(19) United States
(12) Patent Application Publication
(10) Pub. No.: US 2026/0081655 A1
(43) Pub. Date: Mar. 19, 2026

(54) METHOD AND APPARATUS FOR WIRELESS BASEBAND PROCESSING FOR REALIZING INTEGRATED SENSING AND COMMUNICATION

(71) Applicant: BEIJING UNIVERSITY OF POSTS&TELECOMMUNICATIONS, Beijing (CN)

(72) Inventors: Shi YAN, Beijing (CN); Jiupeng ZHANG, Beijing (CN); Mugen PENG, Beijing (CN); Xiqing LIU, Beijing (CN)

(21) Appl. No.: 19/107,151

(22) PCT Filed: Aug. 17, 2023
(86) PCT No.: PCT/CN2023/113592

§ 371 Date: Feb. 27, 2025

(30) Foreign Application Priority Data
Aug. 30, 2022 (CN) 202211060893.X

(51) Int. Cl. H04B 7/06; G01S 7/00; G01S 13/86; H04W 72/0446

(52) U.S. Cl. CPC H04B 7/0617; G01S 7/006; G01S 13/86; H04W 72/0446

(57) ABSTRACT

A method for wireless baseband processing for realizing integrated sensing and communication (ISAC) includes: designing based on a wireless baseband processing procedure of a base station, adding an ISAC beam management module in a transmitter, and adding a sensing function (SF) module to a receiver; sending a wide sensing-communication transmission beam through the ISAC beam management module, and decoding sensing information from a reflected sensing echo through the SF module, the sensing information including a target location; narrowing a beam, aiming at the target location, and sending a narrow sensing-communication transmission beam through the ISAC beam management module based on the sensing information; and designing a manner for separating an uplink communication beam and echo data of a sensing-communication transmission beam received by the base station, the sensing-communication transmission beam including the wide sensing-communication transmission beam and the narrow sensing-communication transmission beam.

### CROSS-REFERENCE TO RELATED APPLICATIONS

This application is a U.S. national phase entry under 35 U.S.C. § 371 of International Application No. PCT/CN2023/113592, filed on Aug. 17, 2023, which claims priority to Chinese Patent Application No. 202211060893.X filed on Aug. 30, 2022, the entire disclosures of which are hereby incorporated herein by reference.

### TECHNICAL FIELD

The present disclosure relates to the field of wireless communication technology, and in particular, to a method and an apparatus for wireless baseband processing for realizing integrated sensing and communication, a communication device, and a storage medium.

### BACKGROUND

Integrated sensing and communication is one of key technologies of the fifth generation mobile communication evolution system. A wireless communication network can obtain physical parameters of a sensing target to assist in improving communication performance. For example, sensing data can be used for beamforming for a user to reduce an amount of beam training and achieve high-gain communication. For example, sensed user physical parameter information can be used to help the user to perform mobility management, to shorten user cell selection, handover and other procedures, which improves the performance of the communication system.

Currently, for a base station, there are two sensing methods designed based on the integrated sensing and communication concept. One is to turn the base station into a dual-carrier device by adding a carrier, in which one carrier is used for communication and the other carrier is used for sensing. This solution requires occupying a large amount of spectrum resources, and the communication and sensing procedures are separated, as completing the sensing and communication procedure through two devices, i.e., a radar and a base station. The other is planning based on a frame structure, communication transmission is turned off and sensing signals are transmitted and received on specific slots. In this solution, the communication and sensing procedures are also separated, and during the sensing procedure, the base station no longer transmits data, which has a greater impact on communication throughput. In addition, the sensing procedure proposed by existing technologies first senses a rough direction of a target through a reference signal access beam, and then senses a precise position and motion information of the target through the sensing signal. However, this sensing procedure can only sense a user accessing the communication and cannot sense other sensing targets that do not have communication capabilities. Moreover, due to the influence of multipath, occlusion, etc., a beam accessed by the user sometimes does not come from a direct direction of the base station.

### SUMMARY

Embodiments of a first aspect of the present disclosure propose a method for wireless baseband processing for realizing integrated sensing and communication (ISAC), including:
designing based on a wireless baseband processing procedure of a base station, adding an ISAC beam management module in a transmitter, and adding a sensing function (SF) module to a receiver;
sending a wide sensing-communication transmission beam through the ISAC beam
management module, and decoding sensing information from a reflected sensing echo through the SF module, in which the sensing information includes a target location;
narrowing a beam, aiming at the target location, and sending a narrow sensing-communication transmission beam through the ISAC beam management module based on the sensing information; and
designing a manner for separating an uplink communication beam and echo data of a sensing-communication transmission beam received by the base station, in which the sensing-communication transmission beam includes the wide sensing-communication transmission beam and the narrow sensing-communication transmission beam, so that the base station separates communication data and sensing data from the uplink communication beam and the echo data.

Embodiments of a second aspect of the present disclosure propose an apparatus for wireless baseband processing for realizing integrated sensing and communication (ISAC), including:
an encoder, configured to encode original information bits to generate a data code stream, obtain an encoding mapping result on each antenna port, and transmit the encoding mapping result through a logical interface;
a carrier modulator, configured to receive the encoding mapping result, modulate the encoding mapping result to a carrier, and obtain and transmit a discrete-time digital signal;
a digital-to-analog converter, configured to convert the carrier modulation result from the discrete-time digital signal into a continuously changing analog signal, and then obtain a sensing-communication signal through orthogonal modulation;
an up-conversion processor, configured to modulate the sensing-communication signal to a radio frequency end transmission frequency band to generate a transmission signal;
an ISAC beam management component, configured to perform a beam management procedure, adjusting a beam shape and direction by adjusting parameters of a basic unit of a multi-antenna array phase through a beamforming technology according to a beam established and maintained by the transmission signal, to obtain a sensing-communication waveform, in which the base station transmits an ISAC signal from multiple antennas according to the sensing-communication waveform;
a down-conversion processor, configured to demodulate the received ISAC signal into a baseband signal to obtain a down-conversion processing result;
an analog-to-digital converter, configured to convert the down-conversion processing result from an analog domain waveform to a digital domain waveform to obtain an analog-to-digital conversion result;
a carrier demodulator, configured to convert the digital domain waveform into a demodulation output signal in a symbol format through a Fourier transform to obtain a carrier demodulation result;
a decoder, configured to receive the carrier demodulation result, process the obtained symbol format to generate a data code stream in a 0-1 bit format, and decode the data code stream to generate estimated bit information; and
a sensing function component, configured to perform sensing signal processing on the analog-to-digital conversion result to obtain sensing data.

Embodiments of a third aspect of the present disclosure proposes a computer device. The device includes a processor, and a memory storing a computer program executable by the processor. The processor is configured to:
design based on a wireless baseband processing procedure of a base station, add an ISAC beam management module in a transmitter, and add a sensing function (SF) module to a receiver;
send a wide sensing-communication transmission beam through the ISAC beam management module, and decode sensing information from a reflected sensing echo through the SF module, in which the sensing information includes a target location;
narrow a beam, aim at the target location, and send a narrow sensing-communication transmission beam through the ISAC beam management module based on the sensing information; and
design a manner for separating an uplink communication beam and echo data of a sensing-communication transmission beam received by the base station, in which the sensing-communication transmission beam includes the wide sensing-communication transmission beam and the narrow sensing-communication transmission beam, so that the base station separates communication data and sensing data from the uplink communication beam and the echo data

Embodiments of a fourth aspect of the present disclosure proposes a non-transitory computer-readable storage medium, on which a computer program is stored. When the computer program is executed by a processor, the method for wireless baseband processing for realizing integrated sensing and communication as described above is implemented.

### BRIEF DESCRIPTION OF THE DRAWINGS

The above and/or additional aspects and advantages of the present disclosure will become apparent and readily understood from the following description of the embodiments in conjunction with the accompanying drawings.

FIG. 1 is a flow chart of a method for wireless baseband processing for realizing integrated sensing and communication provided by an embodiment of the present disclosure.

FIG. 2 is a schematic diagram of a physical layer integrated sensing and communication waveform transmitter provided by an embodiment of the present disclosure.

FIG. 3 is a schematic diagram of a physical layer integrated sensing and communication waveform receiver provided by an embodiment of the present disclosure.

FIG. 4 is a schematic diagram of a wide sensing-communication transmission beam procedure provided by an embodiment of the present disclosure.

FIG. 5 is a schematic diagram of a narrow sensing-communication transmission beam procedure provided by an embodiment of the present disclosure.

FIG. 6 is a schematic diagram of a scheme for separating uplink communication transmission data and uplink sensing echo data in a time domain provided by an embodiment of the present disclosure.

FIG. 7 is a schematic diagram of a scheme for separating uplink communication transmission data and uplink sensing echo data in a time domain provided by an embodiment of the present disclosure.

FIG. 8 is a schematic diagram of an apparatus for wireless baseband processing for realizing integrated sensing and communication provided by an embodiment of the present disclosure.

### DETAILED DESCRIPTION

Embodiments of the present disclosure are described in detail below, examples of which are illustrated in the accompanying drawings, wherein the same or similar reference numerals throughout represent the same or similar elements or elements having the same or similar functions. The embodiments described below with reference to the accompanying drawings are exemplary and intended to explain the present disclosure and are not to be construed as limitations of the present disclosure.

In view of the above-mentioned problems existing in the current technologies, it is necessary to improve a design of a traditional base station, so that the base station has an ability to send an integrated sensing-communication waveform, and can separate and decode communication data and sensing data of a terminal user and other sensing targets, and also realizes a sensing procedure of collaborative communication and fine sensing. To this end, the present disclosure proposes a design solution for a method and an apparatus for wireless baseband processing for realizing integrated communication and sensing.

The method and apparatus for wireless baseband processing for realizing integrated sensing and communication according to embodiments of the present disclosure will be described with reference to the accompanying drawings.

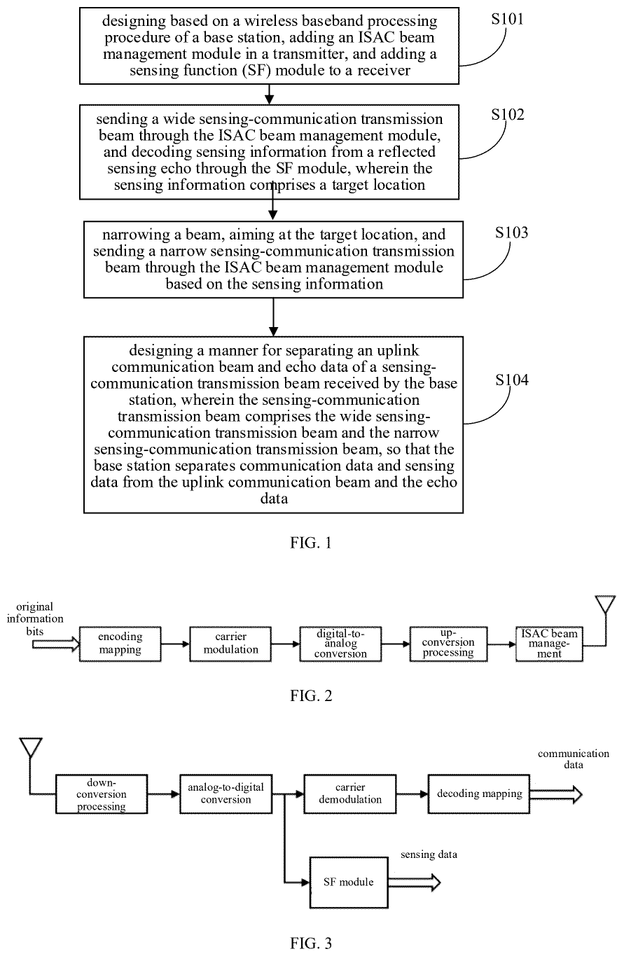

FIG. 1 is a schematic flowchart of a method for wireless baseband processing for realizing integrated sensing and communication provided by an embodiment of the present disclosure.

As shown in FIG. 1, the method for wireless baseband processing for realizing integrated sensing and communication (ISAC) includes the following steps:

S101: designing based on a wireless baseband processing procedure of a base station, adding an ISAC beam management module in a transmitter, and adding a sensing function (SF) module to a receiver;

S102: sending a wide sensing-communication transmission beam through the ISAC beam management module, and decoding sensing information from a reflected sensing echo through the SF module, in which the sensing information includes a target location;

S103: narrowing a beam, aiming at the target location, and sending a narrow sensing-communication transmission beam through the ISAC beam management module based on the sensing information; and

S104: designing a manner for separating an uplink communication beam and echo data of a sensing-communication transmission beam received by the base station, in which the sensing-communication transmission beam includes the wide sensing-communication transmission beam and the narrow sensing-communication transmission beam, so that the base station separates communication data and sensing data from the uplink communication beam and the echo data.

Through the above steps, the SF module and the ISAC beam management module are added to the wireless baseband processing procedure of the traditional base station. Through the SF module, the base station can decode the sensing information from the sensing-communication signals, making the base station have the integrated sensing and communication function. Through the ISAC beam management module, the base station can use the wide sensing-communication transmission beam to achieve large-scale sensing and further adjust the sensing-communication beam through the beamforming technology based on the acquired sensing information, and use and aim the narrow sensing-communication transmission beam to the sensing-communication object to enable high-gain communication with sensing collaborative communication and finer sensing. Finally, the manner for separating the uplink communication data and the reflected sensing data received by the base station is designed, so that the base station can separate the communication and the sensing data from the received data. The embodiments of the present disclosure respectively design the wide transmission sensing-communication transmission beam procedure and the narrow sensing-communication transmission beam procedure, and provide two adaptively selectable schemes to separate the uplink communication transmission data and the uplink sensing echo data in the time domain.

Referring to FIG. 2, for step S101, in order to enable the base station to have the function of sending the ISAC waveform, FIG. 2 shows a schematic diagram of a physical layer integrated sensing and communication waveform transmitter, which is applicable to a radio access network (RAN) side base station. The base station includes: an encoding mapping module, a carrier modulation module, a digital-to-analog conversion module, an up-conversion processing module and an ISAC beam management module.

The encoding mapping module is configured to encode original information bits to generate a data code stream, to scramble and map the data code stream, and to map a 0-1 bit format into a symbol format. After the original information bits obtain one or two codewords in a transmission block through the encoding process, the 0-1 bit format is mapped into the symbol format by scrambling and mapping the encoded bits. Here, generated constellation mapping symbols are then subjected to layer mapping and spatial precoding processing to obtain an encoding mapping symbol on each antenna port. The encoding processing includes, but is not limited to, source coding, channel coding, interleaving, rate matching processing, and other steps. The source coding includes, but is not limited to, Huffman coding. The channel coding includes, but is not limited to, polar codes, LDPC codes, Turbo codes and convolutional codes. The interleaving corrects a sudden error through an interleaver. The rate matching performs different processing based on different code stream lengths after the channel coding, to make the code stream lengths match actual transmission capabilities. The scrambling process performs regular randomization on signal elements. The mapping process includes, but is not limited to, constellation mapping. The encoding mapping symbol is the output result of the encoding mapping module.

The carrier modulation module is configured to receive the encoding mapping result, and modulate the encoding mapping result to a carrier for transmission. The modulation is to select different modulation methods, and the modulation methods include, but are not limited to, single-carrier modulation and multi-carrier modulation. The single-carrier modulation is to modulate the encoding mapping result to a single carrier for transmission, such as QAM, etc. The multi-carrier modulation is to modulate the encoding mapping result to multiple carriers for transmission, such as OFDM, OFTS, etc.

An embodiment of the present disclosure uses the OFDM modulation in the multi-carrier modulation. Since the encoding mapping result is a serial input, serial-to-parallel conversion is first performed to convert high-speed serial transmission into low-speed parallel transmission, and then an inverse fast Fourier transform (IFFT) is used to convert a frequency domain signal into a time domain signal, then parallel-to-serial conversion is performed to convert the signal transmission mode from the parallel transmission to the serial transmission, and finally a cyclic prefix is added to the signal to obtain the carrier modulation result of each antenna port. The carrier modulation result is in a digital signal format.

The digital-to-analog conversion module is configured to convert the carrier modulation result from the digital signal format to an analog signal format.

The up-conversion processing module is configured to modulate a baseband signal to a transmission frequency band for a radio frequency end.

The ISAC beam management module is configured to perform a beam management procedure, establish and maintain an appropriate beam, adjust a beam shape and direction by adjusting parameters of a basic unit of a multi-antenna array phase through a beamforming technology, and obtain a sensing-communication waveform. The beam management procedure includes two parts. The first part is a wide sensing-communication transmission beam management procedure, in which the base station realizes wide-area range sensing by sending a wide sensing-communication transmission beam and decoding sensing data from reflected sensing echo. The second part is a narrow sensing-communication transmission beam management procedure, in which the base station adjusts, based on the sensing data decoded in the first part, an antenna's wave width and up, down, left, and right directions according to a sensing-communication service requirement, to achieve precise three-dimensional beamforming, so that the radiated energy is concentrated on a direction of the terminal device and the sensing object sensed by the first part, and is continuously tracked based on the echo signal to achieve high signal gain communication and more refined sensing.

The beam management procedure executed through the ISAC beam management module includes:
adjusting a parameter of a basic unit of a multi-antenna array phase through a beamforming technology, and adjusting a beam shape and direction, in which the beamforming technology includes a beamforming algorithm, specifically according to a following formula:

$${s}_{T} ( t , α , β ) = {\sum }_{n = 1}^{N} exp ( j \frac{2 π}{λ} ( {x}_{n} cos β sin \partial + {y}_{n} cos β cos α + {z}_{n} sin β ) ) {s}_{n} ( t )$$

where s_{T}(t,α,β) is a composite signal aligned with a spatial angle (α,β), α is a horizontal angle of a beam relative to an antenna boresight, β is a pitch angle of the beam relative to the antenna boresight, and λ is a wavelength of an electromagnetic wave of a sending signal, N is a total number of antennas, (xₙ,yₙ,zₙ) is a position of an n-th antenna unit in space, and sₙ(t) is a scalar representation of a signal to be sent; and
finally emitting an ISAC signal through a transmitting antenna.

Referring to FIG. 3, in order to enable the base station to support the function of receiving and processing the integrated sensing and communication waveform. FIG. 3 shows a schematic diagram of a physical layer integrated sensing and communication waveform receiver proposed by an embodiment of the present disclosure, which is applied to a wireless access network side base station and includes a down-conversion processing module, an analog-to-digital conversion module, a carrier demodulation module, decoding mapping module and sensing function module.

The procedure for the base station to support reception and processing of the integrated sensing and communication waveform includes the following steps.

The integrated sensing and communication signal is received by a receiving antenna.

The received integrated sensing and communication signal is down-converted into a baseband signal through the down-conversion processing module, to obtain a down-conversion processing result. The down-conversion processing result is in an analog signal format.

The down-conversion processing result is converted from the analog signal format to a digital signal format through the analog-to-digital conversion module, to obtain the analog-to-digital conversion result.

The analog-to-digital conversion result is copied, one of the analog-to-digital conversion result is performed with a communication processing procedure, the other analog-to-digital conversion result is performed with a sensing processing procedure.

The communication processing procedure includes: transmitting the analog-to-digital conversion result to the carrier demodulation module through a logical interface. The carrier demodulation module receives the analog-to-digital conversion result, demodulates the analog-to-digital conversion result, and obtains a demodulation output signal, in which the demodulation output signal is in a symbol format. A channel estimation result of each receiving antenna port is then used to perform spatial channel equalization processing on the carrier demodulation result to obtain the carrier demodulation result. The demodulation is to select the corresponding demodulation method according to the modulation method in the carrier modulation module. The demodulation method includes, but is not limited to, single-carrier demodulation and multi-carrier demodulation. For example, the single-carrier demodulation is QAM demodulation, etc.: the multi-carrier demodulation is OFDM demodulation, OTFS demodulation, etc.

An embodiment of the present disclosure uses the OFDM demodulation in the multi-carrier demodulation. First, the signal is processed to remove a cyclic prefix. Since the analog-to-digital conversion result is a serial input, serial-to-parallel conversion is required to convert high-speed serial transmission into low-speed parallel transmission, then a fast Fourier transform (FFT) is used to convert a time domain signal into a frequency domain signal and the frequency domain channel equalization is performed, and finally parallel-to-serial transformation is performed to convert the signal transmission mode from the parallel transmission to the serial transmission, and the demodulated output signal is obtained. The demodulated output signal is in a symbol format.

The decoding mapping module receives the carrier demodulation result, performs spatial deprecoding processing and layer inverse mapping processing, and uses the obtained symbol format to generate a data code stream in 0-1 bit format through inverse mapping, and decodes the data code stream to generate estimated bit information, the estimated bit information is the communication data. The inverse mapping includes, but is not limited to, constellation inverse mapping. The decoding process includes, but is not limited to, deinterleaving, channel decoding, source decoding and other steps. The decoding processing procedure corresponds to the encoding processing procedure of the encoding mapping module, which is not repeated here. The decoding mapping result is the communication data.

The sensing processing procedure includes: transmitting the analog-to-digital conversion result to the sensing function module through a logical interface.

Further, in an embodiment of the present disclosure, sending the wide sensing-communication transmission beam through the ISAC beam management module and decoding the sensing information from the reflected sensing echo through the SF module includes:
obtaining a target sensing-communication request;
establishing and transmitting an initial beam through the base station according to the sensing-communication request, which includes sending the wide sensing-communication transmission beam at a regular period;
receiving uplink communication data and the sensing-communication transmission beam through a receiver of the base station, decoding the reflected sensing data from the uplink communication data and the wide sensing-communication transmission beam, and obtaining the sensing information from the reflected sensing data through the SF module.

The format of the sensing information is point cloud information of signal strength, and each point in the point cloud represents a parameter group consisting of speed, distance, and direction.

Further, in an embodiment of the present disclosure, the wide sensing-communication beam selects and uses, according to a specific sensing-communication service requirement, a beam with a large beam width or a narrow beam with a small beam width for time-division scanning, to cover a large-angle sector area

In some embodiments, the base station initially transmits multiple sensing-communication signals and carries them on different downlink beams. The sensing-communication signals should be transmitted periodically, semi-persistently or aperiodic (event-triggered), with features such as wide coverage, sustainable searchability or periodic broadcasting. The sensing-communication signal includes but is not limited to a synchronization signal (SS) and a physical broadcast channel (PBCH).

In some embodiments, due to the requirement of sensing coverage, the downlink beam may use a beam with a large beam width, or a narrow beam with a small beam width may be used for time division scanning, to cover a large-angle sector area to achieve expansion of the base station sensing for the environment and user terminal sensing range. According to specific sensing service requirements (such as sensing range), the narrow beam time division scanning can determine the azimuths and tilt directions of different beams, use different antenna static weights, and use a beam forming algorithm to generate multiple static narrow beams in different directions for carrying the sensing-communication signals, and uses manners of time-division scanning and transmission one by one when emitting to achieve full coverage of the sensing range.

After the user or application function triggers the sensing-communication request, the base station will establish and send an initial beam according to the sensing-communication request, and before the end of the service, send a wide beam shape sensing-communication waveform at regular intervals to obtain a wide range of sensing information around the base station. After the base station sends the initial beam, the user terminal establishes a beam pair for communication after access. After the base station receiver receives the uplink communication data and reflected sensing data, it decodes the reflected sensing data from the data, and obtains sensing information from the reflected sensing data. The decoding of the reflected sensing data is a signal processing procedure in the receiver, and the obtaining of the sensing information is a signal processing procedure of the sensing function module in the receiver.

Further, in an embodiment of the present disclosure, narrowing the beam, aiming at the target location and sending the narrow sensing-communication transmission beam through the ISAC beam management module based on the sensing information includes:
transmitting multiple sensing-communication signals carried on multiple narrow beams through the base station;
aligning a direction of the narrow sensing-communication transmission beam to a target direction according to the sensing information, and establishing multi-beam pair links with multiple users to achieve communication collaborative sensing.

In some embodiments, the base station transmits multiple sensing-communication signals and carries them on multiple narrow beams. The sensing-communication signals include but are not limited to a channel state information reference signal (CSI-RS), a demodulation reference signal (DMRS), a data payload signal for transmitting data, and other signals. After the base station obtains rough locations of multiple terminal devices and sensing objects from the wide sensing-communication transmission beam echo information, it adjusts a subsequent beam to be sent through the ISAC beam management module and uses the beamforming algorithm to adjust phases of multiple antennas to send signals, narrow the beam and align the direction of the narrowed beam with the direction of the sensing-communication object based on the movement, steering and other behaviors of the sensing object, and establishes multi-beam pair links with multiple users. The base station obtains maximum signal gain in the target direction and achieves sensing accuracy improvement; the integrated sensing-communication base station provides multiple different data code streams for the multiple terminal devices or the multiple sensing objects through multi-access technology, or receives data code streams from the multiple terminals in parallel and receives signal echoes from the multiple sensing objects, obtains the location information of the multiple terminal devices or other sensing objects from the sensed echo information in real time, adjusts and maintains the beam through the ISAC beam management module, and maintains good wireless connection and fine sensing. The multiple access technology includes but is not limited to space division multiple access technology. The beam adjustment procedure first obtains a spatial steering vector of the beam to be transmitted through physical parameters of the sensing information obtained by the sensing processing module, and weights each element on the antenna array elements, so that the output signal of the beamforming algorithm can be narrowed and point to a certain direction, the spatial steering vector may be specifically based on the following formula:

$$a ( θ ) {=}^{△} [ 1 , {e}^{- j 2 π {f}_{0} \frac{d sin ( θ )}{c}} , {e}^{- j 2 π {f}_{0} \frac{2 d sin ( θ )}{c}} , … , {e}^{- j 2 π {f}_{0} \frac{( M - 1 ) d sin ( θ )}{c}} ]$$

In the above formula, θ is an angle between the beam and an antenna boresight, d is a distance between the array elements, f₀ is a frequency of a transmission signal, and c is a propagation speed of an electromagnetic wave.

The antenna element weighting procedure may be specifically based on the following formula:

$$w = {[ {w}_{0} , {w}_{1} , … , {w}_{M - 1} ]}^{T}$$

In the above formula, M is the number of antenna elements, and w is the beamforming weight vector.

The beamforming algorithm may be specifically based on the following formula:

$$y ( t , θ ) {f}_{0} = {\sum }_{i = 1}^{M} {w}_{i}^{H} ( t ) {x}_{i} ( t , θ ) = {w}^{H} x = s ( t ) {w}^{H} a ( θ )$$

In the above formula, y(t,θ) is a signal generated by beamforming, θ is the angle of the beam relative to the antenna boresight, M is the number of elements, xᵢ(t) is a signal on each element, x is an array signal vector, s(t) is the original signal, w^{H} is the beamforming weight vector, and a(θ) is the spatial steering vector.

The procedure of narrowing the beam is a procedure of adjusting the beam width. Specifically, it may be based on the following formula:

$${θ}_{BW} = \frac{k λ}{Nd cos {θ}_{0}}$$

In the above formula, θ_{BW} is the beam width sent by the antenna, which is defined as an angle (rad) between the two directions where radiation power on both sides of a main lobe of the signal sent by the antenna drops by 3 db: k is a beam width factor, and k=0.886 in a case of uniform aperture illumination: λ is a wavelength of an electromagnetic wave for transmitting the signal, N is the number of linear array elements, d is the distance between the array elements, and θ₀ is the angle of the beam relative to the antenna boresight.

In some embodiments, if the sensing-communication signal uses a reference signal, and the reference signal is co-transmitted with the data payload signal, and the modulation and demodulation methods at the transceiver adopts the multi-carrier modulation and demodulation methods, then the proportions of the reference signal and the data payload signal in a resource grid is adaptively adjusted according to the service communication and sensing requirements. For example, in a high-speed mobile scenario or a scenario that only sense but do not communicate, the base station has a higher demand for sensing performance than communication performance. The base station may achieve the high sensing performance requirement by increasing the resource proportion of the reference signal in the resource grid. The resource grid composition includes subcarriers in frequency and symbols in time. The symbols include but are not limited to OFDM symbols, OFTS symbols, etc.

In some embodiments, the proportion of the sensing-communication signal in the resource grid may be adjusted according to the service sensing requirement. For example, higher ranging sensing accuracy may be obtained by increasing the proportion of sensing-communication signal in the frequency domain in the resource grid, or higher speed sensing accuracy may be obtained by increasing the proportion of sensing-communication signal in the time domain in the resource grid.

In some embodiments, sensing signal processing includes:

$$d = \frac{{t}_{r} c}{2}$$

where tᵣ is a delay time between the echo signal and the transmission signal, c is the propagation speed of the electromagnetic wave in the air, and d is the distance between the sensing target and the base station antenna;
calculating a speed of the sensing target based on the propagation speed of the electromagnetic wave in the air, a Doppler frequency shift, and an emission frequency of the ISAC waveform, in which the Doppler frequency shift is a shift between the emission frequency of the ISAC waveform and a frequency of the echo signal, a calculation formula being as follows:

$$v = \frac{c}{2 {f}_{0}} ( {f}_{0}^{′} - {f}_{0} )$$

where c is the propagation speed of the electromagnetic wave in the air, f₀′−f₀ is the Doppler frequency shift, f₀′ is the frequency of the received echo signal, and f₀ is the frequency of the transmission signal; and
obtaining a direction of the sensing target using an antenna array and a direction of arrival estimation technology. The direction of arrival estimation technology includes a BARTLETT algorithm and a MUSIC algorithm.

The BARTLETT algorithm includes:
replacing time domain data in a traditional time domain processing by data received by each array element in a spatial domain according to a phase difference caused by different spatial positions between multiple antenna array elements, and a time difference between the received signals arriving at different antenna array elements at different estimated direction angles is obtained, defining the antenna array to receive k reflected signals, and a calculation formula being as follows:

$${t}_{mk} = \frac{{d}_{m} sin ( {θ}_{k} )}{c}$$

where dₘ is the distance between different receiving antennas, c is the propagation speed of the electromagnetic wave in the air, θₖ is the estimated direction of arrival angle of the received echo signal, tₘₖ is the time difference between the received signals arriving at different antenna array elements; a spatial steering vector in a direction of the incoming wave is constructed based on the time difference between the received signals arriving at different antenna array elements at different estimated direction angles:

$$a ( α ) {=}^{Δ} [ 1 , {e}^{- j 2 π {f}_{0} \frac{d sin ( α )}{c}} , {e}^{- j 2 π {f}_{0} \frac{2 d sin ( α )}{c}} , … , {e}^{- j 2 π {f}_{0} \frac{( M - 1 ) d sin ( α )}{c}} ]$$

where α is the angle between the given incoming wave direction and the antenna boresight, d is the distance between the array elements, f₀ is a frequency of the transmission signal, and c is the propagation speed of the electromagnetic wave: by giving different angle values α, the spatial steering vector is scanned within an array angle range, and a spatial spectrum peak appears at a signal incident position to obtain the direction of the sensing target, in which a specific process is a vector inner product of the spatial steering vector and a received signal vector, as shown in the following formula:

$$y = {a}^{H} ( α ) \cdot x ( n )$$

where a(α) is the spatial steering vector, x(n) is the signal vector received by an antenna array element, and when a scalar y takes a maximum value, a value of α is the estimated angle between the direction of the incoming wave and the antenna boresight, and is output as a direction of arrival estimation result.

The schematic diagram of the design of the physical layer integrated sensing and communication waveform receiver enables the base station to have the function of receiving and processing the integrated sensing and communication waveform.

Referring to FIG. 4, for step S103, in order to make the initial sensing-communication waveform initially sent by the integrated sensing and communication base station sense the terminal device and the sensing object, the embodiments of the present disclosure provide a beam management procedure that the sensing-communication integrated base station initially sends an integrated sensing and communication beam. The initially transmitted integrated sensing and communication beam uses the wide sensing-communication transmission beam procedure, and a scanning range of the sensing-communication transmission beam should cover the entire angular sector served by the base station. FIG. 4 is a schematic diagram of the wide sensing-communication transmission beam.

In some embodiments, as shown in FIG. 4, a downlink beam shape of the transmission and the way of receiving the sensing data are different from other embodiments. The wide sensing-communication transmission beam management procedure is executed (S102) for terminal devices (410a-410c) and a sensing object (420) within the service range of the base station (400). Executing the wide sensing-communication transmission beam management procedure includes the following step.

During the wide sensing-communication transmission beam management procedure, the sensing-communication signal is transmitted. The base station initially transmits multiple sensing-communication signals and carries them on different downlink beams. The downlink beam adopts a beam with a large beam width (450). In order to enable the base station to obtain locations of the sensing terminal devices and sensing object, the sensing-communication signal should be transmitted periodically, semi-persistently or aperiodic (event-triggered), and can be carried on a beam with a large beam width for transmission, and has features such as a wide range of coverage, sustainable searchability or periodic broadcastability, which includes but is not limited to a synchronization signal (SS) and a physical broadcast channel (PBCH) carried by the wide beam. After the base station sends the initial beam, the user terminal establishes the beam pair for communication after access. After the base station receiver receives uplink transmission communication data (470) and uplink sensing echo data (480), it separates reflected sensing data from the data, and obtains sensing information of the terminal devices (410a-410c) and the sensing object (420) from the reflected sensing data. Each time the base station sends the integrated sensing and communication signal, it can receive the sensing beam from the entire coverage area. The executing frequency of sensing is relatively slow; and guard band slots may be allocated according to frame units to receive the sensing data. The decoding of the reflected sensing data is a signal processing procedure in the receiver, and the obtaining of the sensing information is a signal processing procedure of the sensing function module in the receiver.

After the user or an application function triggers the sensing-communication request, the base station will establish and send an initial beam according to the sensing-communication request, and before the end of the service, send the sensing-communication waveform in wide beam shape at regular intervals, to obtain a wide range of sensing information around the base station.

In some other embodiments, the shape of the sent downlink beam and the way of receiving the sensing data are different from other embodiments. The wide sensing-communication transmission beam management procedure is executed (S102) for the terminal devices (410a-410c) and the sensing objects (420) within the service range of the base station (400). Executing the wide sensing-communication transmission beam management procedure includes the following step.

During the wide sensing-communication transmission beam management procedure, the sensing-communication signals are transmitted. The base station initially transmits multiple sensing-communication signals and carries them on different downlink beams. The downlink beam adopts a narrow beam with small beam width for time-division scanning (460a˜460g). In order to enable the base station to sense and obtain the locations of the terminal device and sensing object, the sensing-communication signal should be transmitted periodically, semi-persistently or aperiodic (event-triggered), and has the features such as wide coverage, sustainable searchability, or periodic broadcastability, which includes but is not limited to a synchronization signal (SS) and a physical broadcast channel (PBCH) carried by the time-division narrow beam after beamforming. After the base station sends the initial beam, the user terminal establishes the beam pair for communication after access. After the base station receiver receives uplink transmission communication data (470) and uplink sensing echo data (480), it separates reflected sensing data from the data, and obtain the sensing information of the terminal devices (410a-410c) and the sensing object (420) from the reflected sensing data. Each time the base station sends the integrated sensing and communication signal that is a set of narrow beam signals for time-division scanning, it is necessary to receive the echo signal after sending the narrow beam signals sequentially to perform sensing. The executing frequency of sensing is relatively fast, and slots may be separately allocated after sending the narrow beam signals to receive the sensing data, and the sensing data may also be received by separating dedicated antenna ports. The decoding of the reflected sensing data is a signal processing procedure in the receiver, and the obtaining of the sensing information is a signal processing procedure of the sensing function module in the receiver.

After the user or an application function triggers the sensing-communication request, the base station will establish and send an initial beam according to the sensing-communication request. Before the end of the service, it will send wide-coverage time-division scanning narrow beam sensing-communication waveforms at regular intervals, to obtain the sensing information of the large range of area around the base station.

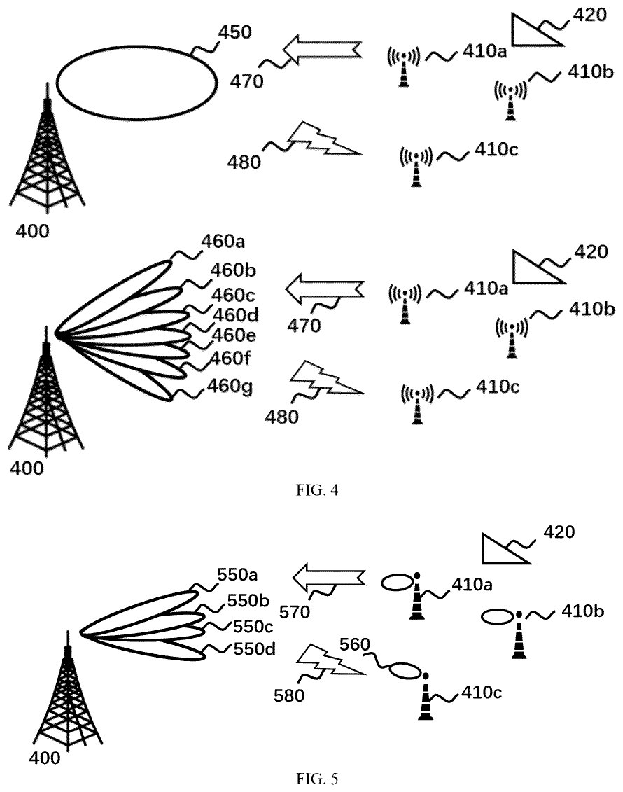

The narrow sensing-communication transmission beam management procedure is executed (S103) for the terminal devices (410a-410c) and the sensing object (420) within the service range of the base station (400). With reference to FIG. 5, executing the narrow sensing-communication transmission beam management procedure includes the following step.

After the base station obtains the rough locations of the terminal devices (410a-410c) and the sensing object (420) from the wide sensing-communication transmission beam echo information (S102), the base station uses the ISAC beam management module to adjust the subsequently transmitted beams (550a-550d), trains the beams, dynamically weights the transmission signal, and uses the beamforming algorithm to adjust the phase of multiple antennas for signal transmission, narrows the beams to form the narrow sensing-communication transmission beams. The multiple sensing-communication signals sent by the base station are carried on the multiple narrow sensing-communication transmission beams, and the sensing-communication signals include but are not limited to signals such as channel state information reference signals (CSI-RS), demodulation reference signals (DMRS), and data payload signals for transmission data. The base station aligns the wide sensing-communication transmission beam direction with the direction of the sensing-communication object. At the same time, if the terminal device also has multiple antennas and has the beam management function, it may also send the narrow transmission beam (560) to establish the beam pair link. After the base station and the terminal device establish the beam pair for communication, each time the narrow sensing-communication transmission beam is sent, the echo signal is received to perform sensing. The base station receiver receives the uplink transmission communication data (570) and the uplink sensing echo data (580), separates the reflected sensing data from the data, obtains the sensing information of the terminal devices (410a-410c) and the sensing object (420) from the reflected sensing data, and tracks the terminal device (410a-410c) and the sensing object (420) based on the obtained sensing information. The decoding of the reflected sensing data is a signal processing procedure in the receiver, and the obtaining of the sensing information is a signal processing procedure of the sensing function module in the receiver. The beam training process may refer to the following formula:

$${Y}^{( E )} [ k ] = {Z}^{*} H [ k ] W + {V}^{( E )} [ k ]$$

where Y^{(E)}[k] is all responses of beam training on a k-th subcarrier, which is a matrix of (n₁*n₂) dimensions, where n₁ represents the receiving end has n₁ beam reception directions, and n₂ represents the transmitting end has n₂ beamforming directions; Z* is a combiner matrix for all beam directions, which is a matrix of (n₁*m) dimensions, where m represents the number of antennas: H[k] is a MIMO channel matrix on a k-th subcarrier; W is a pre-encoder matrix for all beam directions and is a matrix of (m*n₂) dimensions: V^{(E)}[k] is a post-processing noise that may be generated by the beam training on the k-th subcarrier, and is a matrix of (n₁*n₂) dimensions.

Based on the sensing information obtained from the integrated sensing and communication echo signal, the amount of beam training of the base station can be reduced and the performance of the communication system can be improved. The ISAC module then selects an appropriate beam pair during the beam training process to perform beamforming and make the beam to sustainably track the location of the integrated sensing and communication object. Through the narrow sensing-communication transmission beam management procedure, the base station establishes multiple beam pair links with the multiple users, and the base station obtains the maximum signal gain in the target direction and obtains fine sensing.

In an embodiment of the present disclosure, the integrated sensing and communication base station provides multiple different data code streams for the multiple terminal devices or multiple sensing objects through a space division technology, or receives data code streams from the multiple terminals and receives echo signals from the multiple sensing objects in parallel, so as to obtain the location information of the multiple terminal devices or other sensing objects from the sensed echo information in real time, adjust and maintain the beam through the ISAC beam management module, and maintain good wireless connections and fine sensing.

In some embodiments, the embodiments of the present disclosure provide an adaptive sensing-communication solution that can adaptively adjust the sensing mode according to the service communication and sensing requirement.

In some embodiments, if the sensing-communication signal uses the reference signal, and the reference signal and the data payload signal are co-transmitted, proportions of the sensing-communication signal and the data payload signal in a resource grid may be adaptively adjusted according to the service communication and sensing requirement. For example, in a high-speed mobile scenario or a scenario where only sensing is performed and no communication is performed, the base station has a higher requirement for sensing performance than communication performance. The base station may improve the resource proportion of the sensing-communication signal in the resource grid, to achieve high sensing performance requirements.

Further, in an embodiment of the present disclosure, the method also includes:
adjusting the proportion of the sensing-communication signals in a resource grid to adapt to a service sensing requirement, in which the resource grid includes subcarriers in frequency and symbols in time.

Specifically, the proportion of the sensing-communication signals in the resource grid may be adjusted according to the service sensing requirement. For example, higher ranging sensing accuracy may be obtained by increasing the proportion of the sensing-communication signals in the frequency domain in the resource grid, or higher speed sensing accuracy may be obtained by increasing the proportion of the sensing-communication signals in the time domain in the resource grid. The composition of the resource grid includes subcarriers (k) in frequency and OFDM symbols in time.

For step 104, after the base station sends the sensing-communication waveform, the receiver will receive the uplink communication transmission data from the terminal device and the uplink sensing echo data from the sensing object or environment. In order to enable the receiver to separate the received data and decode the communication data and sensing data respectively, it is necessary to design a mode for the receiver to separate the uplink communication transmission data and the uplink sensing echo data.

Further, in one embodiment of the present disclosure, a time domain separating manner is provided for separating the uplink communication beam and the echo data of the sensing-communication transmission beam received by the base station, which specifically includes:
defining a new frame structure in which multiple flexible slots are allocated;
allocating separately a time-frequency domain resource block required for downlink communication transmission in the flexible slots to realize transmission of a sensing-communication signal and communication data in downlink symbols, allocating separately a time-frequency domain resource uniquely occupied by sensing in the flexible slots to receive uplink sensing echo data, and receiving uplink communication transmission data in an uplink slot; and
separating the uplink communication transmission data and the uplink sensing echo data in the time domain.

Further, in an embodiment of the present disclosure, another time domain separating manner is provided for separating the uplink communication beam and the echo data of the sensing-communication transmission beam received by the base station, which specifically includes:
separating reception times for uplink communication transmission data and uplink sensing echo data, in which the uplink communication transmission data is received in an uplink slot, and the uplink sensing echo data is received by occupying time-frequency domain resources of a guard band in flexible slots, and the communication data and the sensing data received at different times are decoded.

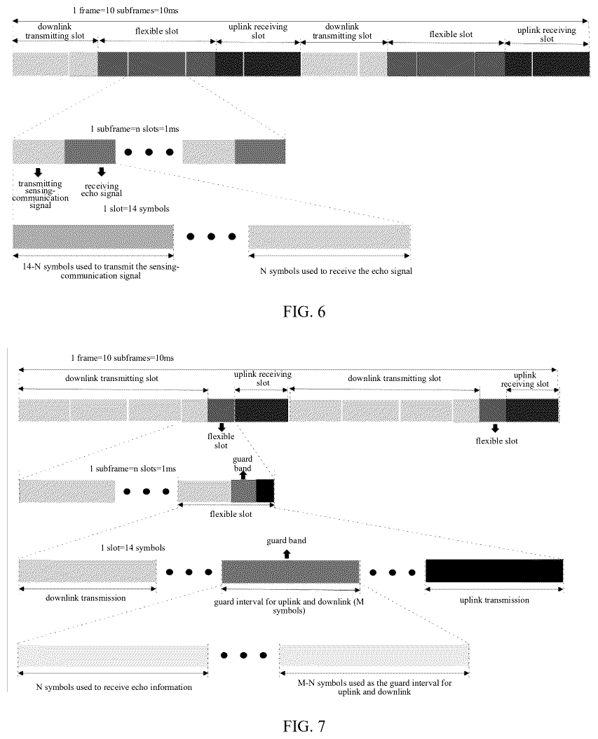

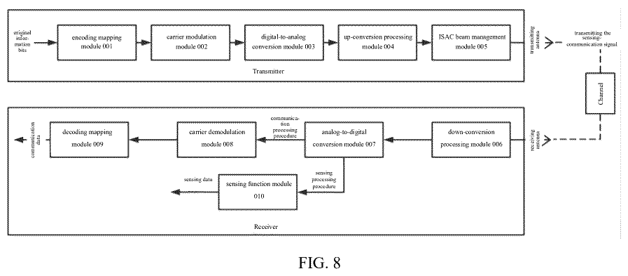

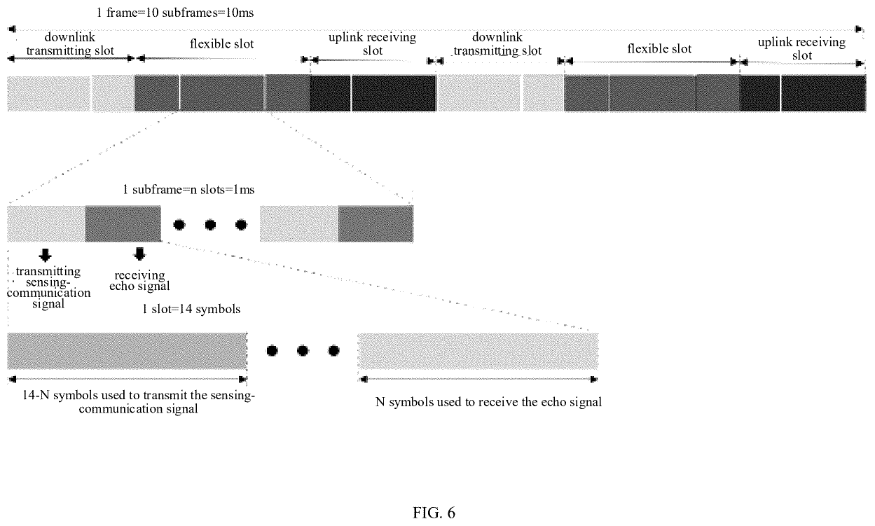

In some embodiments, as shown in FIG. 6, by separating the reception times for the uplink communication transmission data and the uplink sensing echo data, the communication data and sensing data received at different times are decoded. As being different from other embodiments, by allocating separate time-frequency resources to receive the uplink sensing echo data code stream, the purpose of separating the received uplink communication transmission data and the uplink sensing echo data is achieved. This method uses time division multiplexing. By designing the TDD frame structure, separate sensing resources can be allocated at the symbol level, slot level or subframe level to receive the sensing echo data. The sensing frequency is faster, and it needs to design corresponding signaling to indicate these different types of frames.

Generally, a TDD frame cycle in the fifth generation mobile communication technology can be roughly divided into three parts: downlink slots, flexible slots and uplink slots. Referring to FIG. 6, a new TDD frame structure is defined, in which the multiple flexible slots are allocated in the frame structure. the transmission of the sensing signal and the communication data in downlink symbols is achieved by separately allocating the time-frequency domain resource block required for the downlink communication transmission in the flexible slots, the uplink sensing echo data is received by separately allocating the time-frequency domain resource uniquely occupied by sensing in the flexible slots, and the uplink communication transmission data is received in the uplink slots. In this way, the uplink communication transmission data and the uplink sensing echo data are separated in the time domain. In this procedure, an embodiment of the present disclosure adopts a slot structure of ordinary CP. A slot unit in a subframe can be divided into 14 symbols, and then N (14>N>0) symbols are separated to receive the uplink reflected sensing data, the remaining 14-N symbols are still used to transmit the sensing-communication signal and the communication data. The symbol for receiving the downlink reflected sensing data should be arranged after the symbols for transmitting the sensing-communication signal and the communication data. In this embodiment, after the base station triggers the sensing-communication service procedure, the base station transmits a signaling through a PDCCH channel, to configure the frame structure described in the embodiment of the present disclosure, which realizes the separating of the communication/sensing data. It should be noted that, in the present disclosure, the sensing-communication frame structure defined according to the specific sensing-communication service requirement should include multiple types, and appropriate sensing-communication frame structures may be configured through the signalings in different sensing-communication scenarios. The sensing-communication service requirements include but are not limited to sensing coverage and sensing frequency. For example, for a sensing-communication service with high demand for sensing coverage, the uplink sensing echo data may be received by allocating more symbol unit times in the frame structure. The symbols allocated to receive the uplink reflected sensing data are not limited to one slot unit. Taking into account the influence of environmental factors, such as multipath, signal fading and coverage, sufficient time-frequency domain resources for receiving the uplink sensing echo data should be allocated after the sensing-communication signal is sent, to perform the procedure of receiving the sensing data. For another example, for a service with high sensing frequency requirement, the frequency of sensing may be increased by allocating more flexible slots and self-contained slots in the frame structure. In this embodiment, the frequency for performing sensing is in units of slot duration in a subframe.

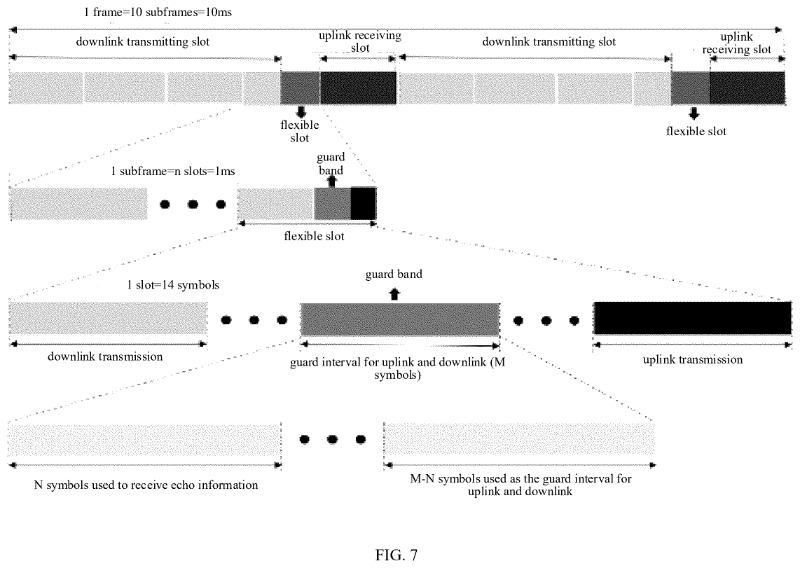

In some other embodiments, as shown in FIG. 7, the separating manner is also a time domain separating manner. The reception times for the uplink communication transmission data and the uplink sensing echo data are separated, and the communication data and sensing data received at different times are decoded. The slots used to receive the reflected sensing data will occupy some of unused slots of the guard band for communication, and the time-frequency resources are allocated to receive the uplink sensing echo data code stream, to achieve the separated reception of the uplink communication transmission data and the uplink sensing echo data. This solution has minor changes to the existing TDD structure and only needs to define some slots in the guard band of the existing frame structure to receive the sensing echo signal.

Generally, the TDD frame cycle in the fifth generation mobile communication technology can be roughly divided into three parts: downlink slots, flexible slots and uplink slots. As shown in FIG. 7, the uplink communication transmission data is received in the uplink slots, and the uplink sensing echo data is received by occupying the time-frequency domain resources of the guard band in the flexible slots, thereby separating the uplink communication transmission data and uplink sensing echo data in the time domain. In this procedure, an embodiment of the present disclosure adopts a slot structure of ordinary CP, in which a slot unit in a subframe can be divided into 14 symbols. There are N time symbols in the flexible slot used as guard interval for uplink and downlink. In the guard interval for uplink and downlink, M (N>M>0) symbols are allocated to receive the downlink reflected sensing data, and the remaining M-N symbols are still used as the guard interval for uplink and downlink. The symbols for receiving the downlink reflected sensing data should be arranged after the symbols for transmitting the downlink communication data, and should be arranged before the guard interval for uplink and downlink. In this embodiment, after the base station sends the sensing-communication signal, the base station needs to receive the echo signal within a specified slot, and the frequency of performing sensing is based on the duration of the frame.

In some embodiments of the present disclosure, there is provided an adaptive sensing-communication method that can adaptively adjust the sensing mode and select different time domain separating manners according to the service communication and sensing requirements. In some embodiments of the present disclosure, sensing slots are separately allocate to receive the sensing data, and the sensing frequency is based on the slot unit in the subframe. The sensing frequency is faster and the sensing performance is improved by sacrificing part of the communication performance. It is suitable for a service scenario with high sensing performance requirement, as a high-speed moving scenario. Some other embodiments of the present disclosure occupy slots in the guard band in the uplink-downlink interval of each frame to receive the sensing data. The sensing frequency is based on the frame unit, and the frequency of performing sensing is slow; which is suitable for a service scenario with low sensing performance requirement. When the base station performs the integrated sensing and communication transmission procedure, the sensing mode can be adaptively selected to meet the communication and sensing requirement.

In addition to the time domain separating manner, the separating manner may also be a code domain separating manner, a spatial domain separating manner, or other manners. The code domain separating manner includes: designing different codebooks for uplink communication transmission data and uplink sensing echo data, separating an uplink communication transmission data code stream and an uplink sensing echo data code stream through codebook cancellation during reception, and decoding the communication data and the sensing data at a receiving end. This separating manner has less impact on the communication capacity and is suitable for complex scenarios, such as a multi-user environment. The spatial domain separation uses a dedicated radio frequency channel to receive the sensing signal. The antenna array is divided into two parts to respectively receive the uplink communication transmission data code stream and the uplink sensing echo data code stream that are different in spatial angles, and the communication data and the sensing data are decoded at the receiving end. This separating manner requires sacrificing the communication spatial domain resources to receive the sensing data, which will partially affect the communication performance, and this separating manner requires the base station to have full-duplex capabilities or equivalent capabilities, but it is simple to implement. The code domain separating and spatial domain separating manners are optional supplementary embodiments and will not be described again here.

The wireless baseband processing for realizing the integrated sensing and communication proposed by the embodiments of the present disclosure is designed for the transmitter and receiver applied to the physical layer of the base station. The ISAC beam management module is added in the transmitter, and the beam management procedure is specifically designed in this module. Specifically, the beam processing methods are respectively proposed for different beam management stages. Through this module, the sensing procedure of sensing collaborative communication and fine sensing is realized. The sensing function module is added in the receiver, through which the base station can decode the sensing-communication information from the sensing-communication signals, which makes the base station have the sensing-communication function. Finally, the manner for separating the uplink communication data and the reflected sensing data received by the base station is designed, so that the base station can separate the communication data and the sensing data from the received data. The solution can solve the problems in the existing technologies that the sensing-communication base station cannot send the integrated sensing and communication waveforms, cannot separate and decode the communication data and sensing data of the terminal user and the sensing target, and the sensing procedure cannot sense the sensing object that does not access communication.

In order to implement the above embodiments, the present disclosure also proposes an apparatus for wireless baseband processing for realizing integrated sensing and communication.

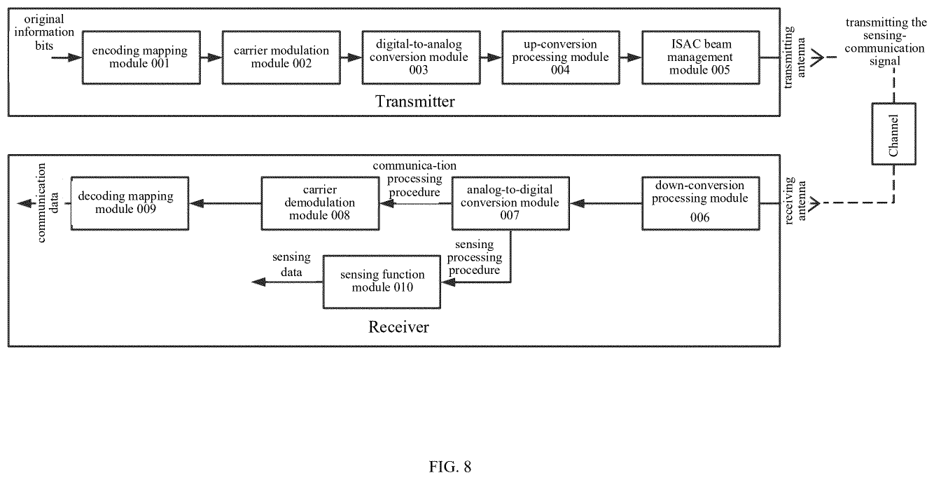

FIG. 8 is a schematic structural diagram of an apparatus for wireless baseband processing for realizing integrated sensing and communication provided by an embodiment of the present disclosure.

As shown in FIG. 8, the apparatus for wireless baseband processing for realizing integrated sensing and communication includes: an encoding mapping module 001, a carrier modulation module 002, a digital-to-analog conversion module 003, an up-conversion processing module 004, an ISAC beam management module 005, a down-conversion processing module 006, an analog-to-digital conversion module 007, a carrier demodulation module 008, a decoding mapping module 009, a sensing function module 010.

The encoding mapping module 001 is configured to encode original information bits to generate a data code stream, obtain an encoding mapping result on each antenna port, and transmit the encoding mapping result through a logical interface.

The carrier modulation module 002 is configured to receive the encoding mapping result, modulate the encoding mapping result to a carrier, obtain and transmit a discrete time digital signal.

The digital-to-analog conversion module 003 is configured to convert the carrier modulation result from the discrete-time digital signal into a continuously changing analog signal, and then obtain a sensing-communication signal through orthogonal modulation.

The up-conversion processing module 004 is configured modulate the sensing-communication signal to a radio frequency end transmission frequency band to generate a transmission signal.

The ISAC beam management module 005 is configured to perform a beam management procedure, adjusting a beam shape and direction by adjusting parameters of a basic unit of a multi-antenna array phase through a beamforming technology according to a beam established and maintained by the transmission signal, to obtain a sensing-communication waveform, in which the base station transmits an ISAC signal from multiple antennas according to the sensing-communication waveform.

The down-conversion processing module 006 is configured to demodulate the received ISAC signal into a baseband signal to obtain a down-conversion processing result.

The analog-to-digital conversion module 007 is configured to convert the down-conversion processing result from an analog domain waveform to a digital domain waveform to obtain an analog-to-digital conversion result.

The carrier demodulation module 008 is configured to convert the digital domain waveform into a demodulation output signal in a symbol format through a Fourier transform to obtain a carrier demodulation result.

The decoding mapping module 009 is configured to receive the carrier demodulation result, process the obtained symbol format to generate a data code stream in a 0-1 bit format, and decode the data code stream to generate estimated bit information.

The sensing function module 010 is configured to perform sensing signal processing on the analog-to-digital conversion result to obtain sensing data.

To achieve the above object, embodiments of a third aspect of the present disclosure proposes a computer device. The device includes a memory, a processor, and a computer program stored on the memory and executable on the processor. When the processor executes the computer program, the method for wireless baseband processing for realizing integrated sensing and communication as described above is implemented.

In order to achieve the above object, embodiments of a fourth aspect of the present disclosure proposes a computer-readable storage medium, on which a computer program is stored. When the computer program is executed by a processor, the method for wireless baseband processing for realizing integrated sensing and communication as described above is implemented.

In order to achieve the above object, embodiments of a fifth aspect of the present disclosure proposes a computer program product, including a computer program. When the computer program is executed by a processor, the method for wireless baseband processing for realizing integrated sensing and communication as described above is implemented.

In the description of the specification, reference to the terms “one embodiment,” “some embodiments,” “an example,” “a specific example”, or “some examples” or the like means that specific features, structures, materials, or characteristics described in connection with the embodiment or example are included in at least one embodiment or example of the present disclosure. In this specification, the schematic expressions of the above terms are not necessarily directed to the same embodiment or example. Furthermore, the specific features, structures, materials or characteristics described may be combined in any suitable manner in any one or more embodiments or examples. Furthermore, those skilled in the art may combine and combine different embodiments or examples and features of different embodiments or examples described in this specification unless they are inconsistent with each other.

In addition, the terms “first” and “second” are merely used for descriptive purposes and cannot be understood as indicating or implying relative importance or implicitly indicating the quantity of indicated technical features. Therefore, features defined as “first” and “second” may explicitly or implicitly include at least one of these features. In the description of the present disclosure, “a plurality of” means at least two, such as two, three, etc., unless otherwise expressly and specifically limited.

Although the embodiments of the present disclosure have been shown and described above, it can be understood that the above-mentioned embodiments are illustrative and should not be construed as limitations of the present disclosure. Those of ordinary skill in the art can make changes, modifications, substitutions and variations to the above-mentioned embodiments within the scope of the present disclosure.

1. A method for wireless baseband processing for realizing integrated sensing and communication (ISAC), comprising:
designing based on a wireless baseband processing procedure of a base station, adding an ISAC beam management module in a transmitter, and adding a sensing function (SF) module to a receiver;
sending a wide sensing-communication transmission beam through the ISAC beam management module, and decoding sensing information from a reflected sensing echo through the SF module, wherein the sensing information comprises a target location;
narrowing a beam, aiming at the target location, and sending a narrow sensing-communication transmission beam through the ISAC beam management module based on the sensing information; and
designing a manner for separating an uplink communication beam and echo data of a sensing-communication transmission beam received by the base station, wherein the sensing-communication transmission beam comprises the wide sensing-communication transmission beam and the narrow sensing-communication transmission beam, so that the base station separates communication data and sensing data from the uplink communication beam and the echo data.

2. The method according to claim 1, wherein a beam management procedure performed by the ISAC beam management module comprises:
adjusting a parameter of a basic unit of a multi-antenna array phase through a beamforming technology, and adjusting a beam shape and direction, wherein the beamforming technology comprises a beamforming algorithm, specifically according to a following formula:
$${s}_{T} ( t , α , β ) = {\sum }_{n = 1}^{N} exp ( j \frac{2 π}{λ} ( {x}_{n} cos β sin \partial + {y}_{n} cos β cos α + {z}_{n} sin β ) ) {s}_{n} ( t )$$
where s_{T}(t,α,β) is a composite signal aligned with a spatial angle (α,B), α is a horizontal angle of a beam relative to an antenna boresight, β is a pitch angle of the beam relative to the antenna boresight, and λ is a wavelength of an electromagnetic wave of a sending signal, N is a total number of antennas, (xₙ,yₙ,zₙ) is a position of an n-th antenna unit in space, and sₙ(t) is a scalar representation of a signal to be sent; and
emitting an ISAC signal through a transmitting antenna.

3. The method according to claim 1, wherein sending the wide sensing-communication transmission beam through the ISAC beam management module and decoding the sensing information from the reflected sensing echo through the SF module comprises:
obtaining a target sensing-communication request;
establishing and transmitting an initial beam through the base station according to the target sensing-communication request, which comprises sending the wide sensing-communication transmission beam at a regular period; and
receiving uplink communication data and the sensing-communication transmission beam through a receiver of the base station, decoding the reflected sensing data from the uplink communication data and the wide sensing-communication transmission beam, and obtaining the sensing information from the reflected sensing data through the SF module.

4. The method according to claim 3, wherein the wide sensing-communication transmission beam selects and uses, according to a specific sensing-communication service requirement, a beam with a large beam width or a narrow beam with a small beam width for time-division scanning, to cover a large-angle sector area.

5. The method according to claim 1, wherein narrowing a beam, aiming at the target location and sending the narrow sensing-communication transmission beam through the ISAC beam management module based on the sensing information comprises:
transmitting multiple sensing-communication signals carried on multiple narrow beams through the base station; and
aligning a direction of the narrow sensing-communication transmission beam to a target direction according to the sensing information, and establishing multi-beam pair links with multiple users to achieve communication collaborative sensing.

6. The method according to claim 5, wherein the multiple sensing-communication signals comprise a channel state information reference signal (CSI-RS), a demodulation reference signal (DMRS), a data payload signal for transmitting data, and other signals.

7. The method according to claim 5, further comprising:
adjusting a proportion of the multiple sensing-communication signals in a resource grid to adapt to a service sensing requirement, wherein the resource grid comprises subcarriers in frequency and symbols in time.

8. The method according to claim 1, wherein the manner for separating the uplink communication beam and the echo data of the sensing-communication transmission beam received by the base station is a time domain separating manner, and designing the manner for separating the uplink communication beam and the echo data of the sensing-communication transmission beam received by the base station comprises:
defining a new frame structure in which multiple flexible slots are allocated;
allocating separately a time-frequency domain resource block required for downlink communication transmission in the multiple flexible slots to realize transmission of a sensing-communication signal and communication data in downlink symbols, allocating separately a time-frequency domain resource uniquely occupied by sensing in the multiple flexible slots to receive uplink sensing echo data, and receiving uplink communication transmission data in an uplink slot; and
separating the uplink communication transmission data and the uplink sensing echo data in a time domain.

9. The method according to claim 1, wherein the manner for separating the uplink communication beam and the echo data of the sensing-communication transmission beam received by the base station is a time domain separating manner, and designing the manner for separating the uplink communication beam and the echo data of the sensing-communication transmission beam received by the base station comprises:
separating reception times for uplink communication transmission data and uplink sensing echo data, wherein the uplink communication transmission data is received in an uplink slot, and the uplink sensing echo data is received by occupying time-frequency domain resources of a guard band in flexible slots, and the communication data and the sensing data received at different times are decoded.

10. The method according to claim 1, wherein the manner for separating the uplink communication beam and the echo data of the sensing-communication transmission beam received by the base station is a code domain separating manner, and designing the manner for separating the uplink communication beam and the echo data of the sensing-communication transmission beam received by the base station comprises:
designing different codebooks for uplink communication transmission data and uplink sensing echo data, separating an uplink communication transmission data code stream and an uplink sensing echo data code stream through codebook cancellation during reception, and decoding the communication data and the sensing data at a receiving end.

11. The method according to claim 1, wherein the manner for separating the uplink communication beam and the echo data of the sensing-communication transmission beam received by the base station is a spatial domain separating manner, and designing the manner for separating the uplink communication beam and the echo data of the sensing-communication transmission beam received by the base station comprises:
using a dedicated radio frequency channel to receive a sensing signal, dividing an antenna array into two parts to receive an uplink communication transmission data code stream and an uplink sensing echo data code stream that are different in spatial angles, and decoding the communication data and the uplink sensing echo data code stream at a receiving end.

12. An apparatus for wireless baseband processing for realizing integrated sensing and communication (ISAC), including:
an encoder, configured to encode original information bits to generate a data code stream, obtain an encoding mapping result on each antenna port, and transmit the encoding mapping result through a logical interface;
a carrier modulator, configured to receive the encoding mapping result, modulate the encoding mapping result to a carrier, and obtain and transmit a discrete-time digital signal;
a digital-to-analog converter, configured to convert the carrier modulation result from the discrete-time digital signal into a continuously changing analog signal, and then obtain a sensing-communication signal through orthogonal modulation;
an up-conversion processor, configured to modulate the sensing-communication signal to a radio frequency end transmission frequency band to generate a transmission signal;
an ISAC beam management component, configured to perform a beam management procedure, adjust a beam shape and direction by adjusting parameters of a basic unit of a multi-antenna array phase through a beamforming technology according to a beam established and maintained by the transmission signal, to obtain a sensing-communication waveform, wherein a base station transmits an ISAC signal from multiple antennas according to the sensing-communication waveform;
a down-conversion processor, configured to demodulate the received ISAC signal into a baseband signal to obtain a down-conversion processing result;
an analog-to-digital converter, configured to convert the down-conversion processing result from an analog domain waveform to a digital domain waveform to obtain an analog-to-digital conversion result;
a carrier demodulator, configured to convert the digital domain waveform into a demodulation output signal in a symbol format through a Fourier transform to obtain a carrier demodulation result;
a decoding mapping decoder, configured to receive the carrier demodulation result, process the obtained symbol format to generate a data code stream in a 0-1 bit format, and decode the data code stream to generate estimated bit information; and
a sensing function component, configured to perform sensing signal processing on the analog-to-digital conversion result to obtain sensing data.

13. The apparatus according to claim 12, wherein the analog-to-digital converter is further configured to copy the analog-to-digital conversion result to obtain two analog-to-digital conversion results, wherein one of which is performed with a communication processing procedure, another analog-to-digital conversion result is performed with a sensing processing procedure.

14. The apparatus according to claim 13, wherein the communication processing procedure comprises: transmitting the analog-to-digital conversion result to the carrier demodulator through a logical interface.

15. The apparatus according to claim 13, wherein the sensing processing procedure comprises: transmitting the analog-to-digital conversion result to the sensing function component through a logical interface.

16. The apparatus according to claim 12, wherein the sensing signal processing comprises:
calculating a distance between a sensing target and a base station antenna based on a delay time between an echo signal and a transmission signal and a propagation speed of an electromagnetic wave in air, a calculation formula being as follows:
$$d = \frac{{t}_{r} c}{2}$$
where tᵣ is the delay time between the echo signal and the transmission signal, c is the propagation speed of the electromagnetic wave in the air, and d is the distance between the sensing target and the base station antenna;
calculating a speed of the sensing target based on the propagation speed of the electromagnetic wave in the air, a Doppler frequency shift, and an emission frequency of the ISAC waveform, wherein the Doppler frequency shift is a shift between the emission frequency of the ISAC waveform and a frequency of the echo signal, a calculation formula being as follows:
$$v = \frac{c}{2 {f}_{0}} ( {f}_{0}^{′} - {f}_{0} )$$
where c is the propagation speed of the electromagnetic wave in the air,
$${f}_{0}^{′} - {f}_{0}$$
is the Doppler frequency shift,
$${f}_{0}^{′}$$
is the frequency of the received echo signal, and f₀ is the frequency of the transmission signal; and
obtaining a direction of the sensing target using an antenna array and a direction of arrival estimation technology.

17. The apparatus according to claim 16, wherein obtaining the direction of the sensing target using the antenna array and the direction of arrival estimation technology comprises:
replacing time domain data in a traditional time domain processing by data received by each array element in a spatial domain according to a phase difference caused by different spatial positions between multiple antenna array elements, and a time difference between the received signals arriving at different antenna array elements at different estimated direction angles is obtained, defining the antenna array to receive k reflected signals, and a calculation formula being as follows:
$${t}_{mk} = \frac{{d}_{m} sin ( {θ}_{k} )}{c}$$
where dₘ is the distance between different receiving antennas, c is the propagation speed of the electromagnetic wave in the air, θₖ is the estimated direction of arrival angle of the received echo signal, tₘₖ is the time difference between the received signals arriving at different antenna array elements; a spatial steering vector in a direction of the incoming wave is constructed based on the time difference between the received signals arriving at different antenna array elements at different estimated direction angles:
$$a ( θ ) {=}^{Δ} [ 1 , {e}^{- j 2 π {f}_{0} \frac{d sin ( θ )}{c}} , {e}^{- j 2 π {f}_{0} \frac{2 d sin ( θ )}{c}} , … , {e}^{- j 2 π {f}_{0} \frac{( M - 1 ) d sin ( θ )}{c}} ]$$
where θ is the angle between the given incoming wave direction and the antenna boresight, d is the distance between the array elements, f₀ is a frequency of the transmission signal, and c is the propagation speed of the electromagnetic wave; by giving different angle values α, the spatial steering vector is scanned within an array angle range, and a spatial spectrum peak appears at a signal incident position to obtain the direction of the sensing target, wherein a specific process is a vector inner product of the spatial steering vector and a received signal vector, as shown in the following formula:
$$y = {a}^{H} ( α ) \cdot x ( n )$$
where a(α) is the spatial steering vector, x(n) is the signal vector received by an antenna array element, and when a scalar y takes a maximum value, a value of α is the estimated angle between the direction of the incoming wave and the antenna boresight, and is output as a direction of arrival estimation result.

18. A computer device, comprising:
a processor; and
a memory storing a computer program executable by the processor, wherein the processor is configured to;
design based on a wireless baseband processing procedure of a base station, add an integrated sensing and communication (ISAC) beam management module in a transmitter, and add a sensing function (SF) module to a receiver;
send a wide sensing-communication transmission beam through the ISAC beam management module, and decode sensing information from a reflected sensing echo through the SF module, wherein the sensing information comprises a target location;
narrow a beam, aim at the target location, and send a narrow sensing-communication transmission beam through the ISAC beam management module based on the sensing information; and
design a manner for separating an uplink communication beam and echo data of a sensing-communication transmission beam received by the base station, wherein the sensing-communication transmission beam comprises the wide sensing-communication transmission beam and the narrow sensing-communication transmission beam, so that the base station separates communication data and sensing data from the uplink communication beam and the echo data.

19. A non-transitory computer-readable storage medium having stored thereon a computer program that, when executed by a processor, the method according to claim 1 is implemented.

20. (canceled)
